(19) United States
(12) Patent Application Publication
(10) Pub. No.: US 2009/0318200 A1
(43) Pub. Date: Dec. 24, 2009

(54) MOBILE PHONE

(75) Inventor: DA-WEI HUANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/239,838

(22) Filed: Sep. 29, 2008

(30) Foreign Application Priority Data
Jun. 18, 2008 (CN) 200810302172.9

(51) Int. Cl. H04M 1/00

(52) U.S. Cl. 455/575.1

(57) ABSTRACT

A mobile phone includes a protractor and a ruler.

### BACKGROUND

1. Technical Field

The present disclosure relates to a mobile phone.

2. Description of the Related Art

Nowadays, mobile phones are an essential part of our daily lives. Therefore, there is a need for the mobile phones to have as much functionalities as possible in order to make our lives more convenient.

### BRIEF DESCRIPTION OF THE DRAWINGS

FIG. 1 is a planar view of a mobile phone, according to an exemplary embodiment.

FIG. 2 is another planar view of the mobile phone of FIG. 1 from another perspective.

FIG. 3 is a planar view of a mobile phone, according to another exemplary embodiment.

FIG. 4 is a planar view of a mobile phone, according to a further exemplary embodiment.

### DETAILED DESCRIPTION OF THE EMBODIMENTS

Embodiments of the present mobile phone will now be described in detail with references to the accompanying drawings.

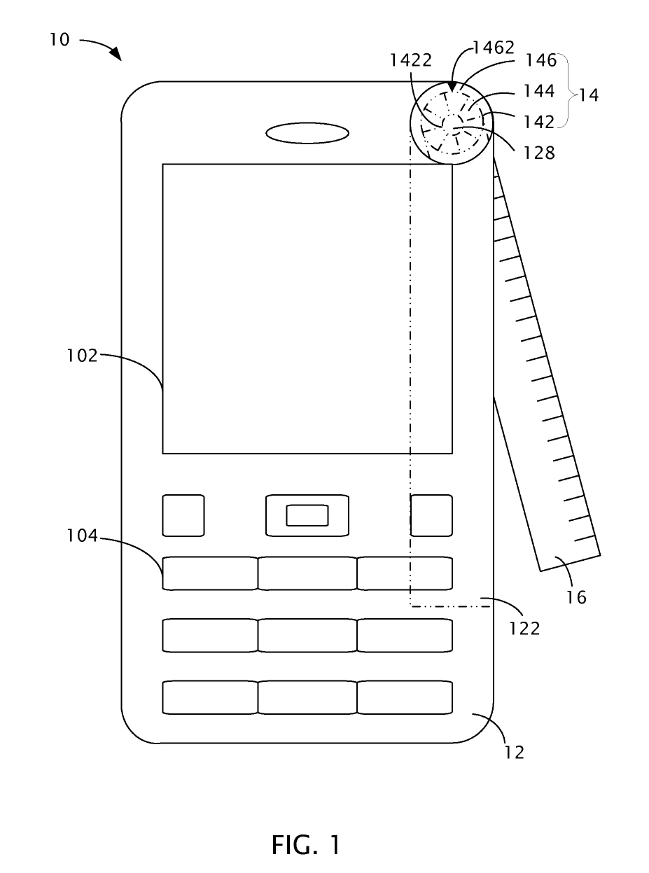

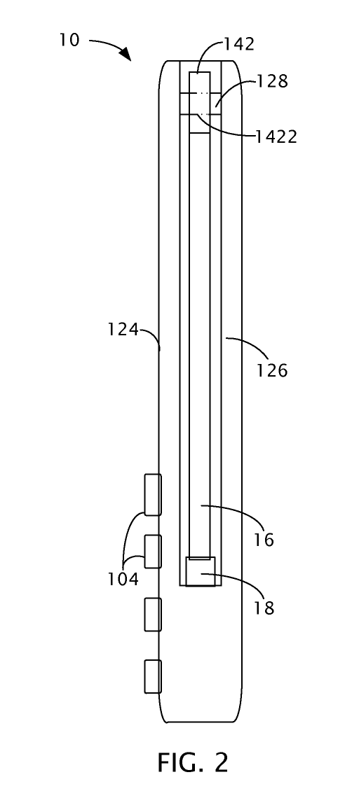

Referring to FIGS. 1 and 2, a mobile phone 10, according to an exemplary embodiment, includes a housing 12, a protractor 14, and a ruler 16. The housing 12 defines a groove 122 therein. The protractor 14 includes a rotating portion 142, a dial 144, and an observation window 146. The rotating portion 142 is rotatably mounted within the groove 122. The dial 144 is formed on the rotating portion 142. The observation window 146 is made of transparent material, e.g., glass, and embedded in the housing 12, facing the dial 144. Therefore, the dial 144 can be read through the observation window 146. The observation window 146 also includes an indicator 1462 formed thereon. As a result, the indicator 1462 can indicate the angle at which the rotating portion 142 rotates. The ruler 16 is connected to the rotating portion 142 and is shaped to be receivable within the groove 122. In other words, both the length and width of the groove 122 are greater than those of the ruler, respectively. In other alternative embodiments, the groove 122, the rotating portion 142, and the ruler 16 can be shaped so that only a part of the rotating portion 142 and/or the ruler 16 are received in the groove 122. Alternatively, the groove 122 can be omitted. The rotating portion 142 and the ruler 16 are attached to and rest against the housing 12.

In this embodiment, the mobile phone 10 is a bar phone. The housing 12 includes a front surface 124 and four side surfaces. The mobile phone 10 further includes a display 102 and a keypad 104 mounted in the front surface 124. The groove 122 can be defined in the right side surface 126 of the mobile phone 10. Accordingly, the observation window 146 is positioned on the top right corner of the front surface 124, aligning with the rotating portion 142. The dial 144 is formed on the rotating portion 142, facing the observation window 146.

However, the detailed structure of the rotating portion 142, the dial 144, and the observation window 146 is not limited by this embodiment. Alternatively, the observation window 146 may be positioned on bottom right corner of the front surface 124. The groove 122 can also be defined in other side surfaces, e.g., the left, upper, and bottom side surfaces of the mobile phone 10; the positions of the rotating portion 142, the dial 144 can be changed; and the observation window 146 may be in/on the housing 12.

In other alternative embodiments, the dial 144 can be formed on the observation window 146. Accordingly, the indicator 1462 is formed on the rotating portion 142. Therefore, the indicator 1462 can indicate the angle at which the rotating portion 122 rotates.

Alternatively, the mobile phone 10 can be a clamshell/slip phone or a slide phone. The clamshell and slide phones typically include a display section and a main body section that are pivoted together (not shown). The groove 122 can be defined in one of the side surfaces of the display section or the main body section.

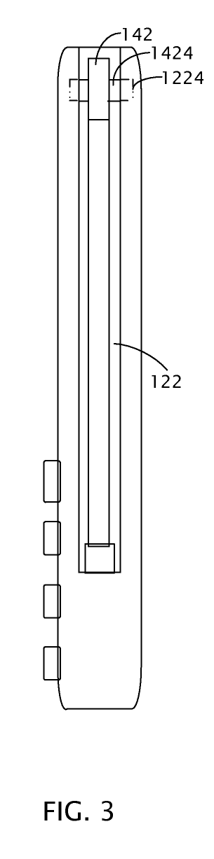

In order to rotatably receive the rotating portion 142, the housing 12 forms a shaft 128. The shaft 128 crosses the groove 122 along the width of the groove 122 and is positioned near one of the distal ends of the groove 122. The rotating portion 142 is disc-like and defines a through hole 1422. The rotating portion 142 is received in the groove 122 with the shaft 128 inserted into the central through hole 1422. Therefore, the rotating portion 142 is capable of rotating about the shaft 128 within the groove 122. Other rotatable structures can be employed to rotatably mount the rotating portion 142 within the groove 122 as well. For example, referring to FIG. 3, the rotating portion 142 may be integrally formed with a spindle 1424, the groove 122 forms a pair of spindle receivers 1224. The rotating portion 142 is received within the groove 122 with the spindle 1424 rotatably received in the pair of spindle receivers 1224.

The graduation of the dial 144 is in degrees. Though only eight graduations are shown on the dial 144, it is understood that a real dial may be formed with more graduations, e.g., 1 degree intervals. The indicator 1462 is a black arrow pointing to the dial, but it also can be other indicative geometrical pointers. The dial 144 and the indicator 1462 are aligned so that when the ruler 16 is received in the groove 122 the indicator 1462 points to the origin (0 degree) of the dial 144. Being structured as such, the protractor 14 is capable of measuring the included angle between the side surface 126 and ruler 16.

In this embodiment, the observation window 146 is circular in shape. However, the observation window 146 can exude other geometrical shapes as well. The observation window 146 has a diameter greater than that of the dial 144. The indicator 1462 is positioned so that the orthographic projection of the indicator 1462 on the rotating portion 142 adjoins the periphery of the dial 144.

The ruler 16 is scaled and thereby can be used for length measurement when unfolded away from groove 122. Optionally, the mobile phone 10 further includes an ejecting member 18. The ejecting member 18 is configured for securing the ruler 16 when the ruler 16 has been folded into the groove 122 and ejecting the ruler 16 out of the groove 122 when triggered.

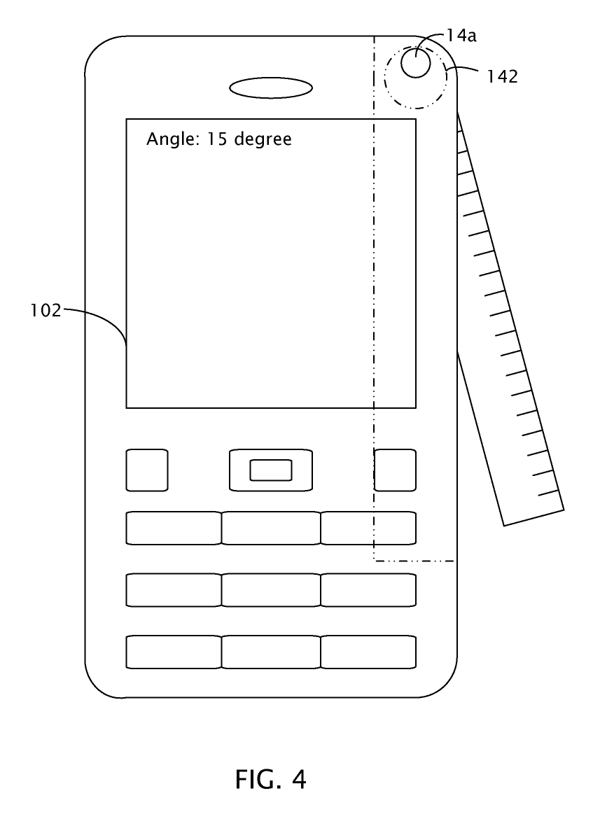

The protractor 14 is not limited to this embodiment. Referring to FIG. 4, another embodiment, instead of the dial 144 and the observation window 146, an angle sensor 14a can be used. The angle sensor 14a is installed in the rotating portion 142 and can automatically measure an angle that the rotating portion 142 rotates and output the result to an output port, e.g., the display 102 or the speakers. In particular, assistant software is required for receiving the output of the angle sensor and transferring the output into displayable information on the display 102 or to the mobile phone speakers.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A mobile phone comprising:
a housing defining a groove therein;
a protractor comprising:
a rotating portion rotatably mounted in the groove;
a dial formed on the rotating portion; and
a transparent observation window embedded in the housing, facing the dial, and comprising an indicator formed thereon, the indicator being configured for indicating a angular rotation the rotating portion rotates; and
a ruler connected to the rotating portion and shaped to be receivable in the groove.

2. The mobile phone as claimed in claim 1, wherein the rotating portion is partially received in the groove.

3. The mobile phone as claimed in claim 1, wherein the ruler is partially received in the groove.

4. The mobile phone as claimed in claim 1, wherein the housing comprises a front surface and a plurality of side surfaces, the groove being defined in one of the side surfaces, the observation window being positioned on the front surface and in alignment with the rotating portion, the dial facing the observation window.

5. The mobile phone as claimed in claim 1, wherein the housing comprises a shaft, the shaft crossing the groove along the width of the groove and positioned near one of the distal ends of the groove, the rotating portion defining a central through hole therein, the rotating portion being mounted in the groove with the shaft inserting into the central through hole.

6. The mobile phone as claimed in claim 1, wherein the rotating portion comprising a spindle, the groove forming two spindle receivers, the rotating portion being mounted in the groove with the spindle rotatably received in the spindle receivers.

7. The mobile phone as claimed in claim 1, wherein the indicator comprises a geometrical pointer, the dial being graduated, the indicator pointing to the origin graduation of the dial when the ruler is received in the groove.

8. The mobile phone as claimed in claim 1, wherein the housing comprises a side surface, the groove being defined in the side surface, the protractor being capable of measuring an included angle between the side surface and the ruler.

9. The mobile phone as claimed in claim 1, wherein the dial and the transparent observation window are disc-like, the diameter of the transparent observation window being greater than that of the dial, the indicator being formed so that the orthographic projection of the indicator on the rotating portion adjoins the periphery of the dial.

10. The mobile phone as claimed in claim 1, further comprising an ejecting member, the ejecting member being capable of securing the ruler when ruler is folded in the groove and ejecting the ruler out of the groove when triggered.

11. A mobile phone comprising:
a housing defining a groove therein;
a protractor comprising:
a rotating portion; and
an angle sensor installed on the rotating portion; and
a ruler connected to the rotating portion and shaped to be receivable in the groove.

12. A mobile phone comprising a protractor and a ruler.

13. The mobile phone as claimed in claim 12, further comprising a housing, the protractor and the ruler being attached to the housing.

14. The mobile phone as claimed in claim 12, further comprising a housing, the housing defining a groove therein, the protractor comprising:
a rotating portion rotatable mounted in the groove;
an indicator formed on the rotating portion; and
a transparent observation window embedded in the housing, aligning with the rotating portion, and comprising a dial formed thereon, the indicator and the dial being formed to be capable of measuring the angle at which the rotating portion rotates.
